(19) United States
(12) Patent Application Publication
(10) Pub. No.: US 2026/0029333 A1
(43) Pub. Date: Jan. 29, 2026

(54) IMAGE INSPECTION APPARATUS AND PRINTING APPARATUS

(71) Applicant: SCREEN Holdings Co., Ltd., Kyoto (JP)

(72) Inventors: Yuya TAKAGI, Kyoto-shi (JP); Shigenori ARIZONO, Kyoto-shi (JP); Kenichi YOKOUCHI, Kyoto-shi (JP); Hirotake NISHIMURA, Kyoto-shi (JP); Koichi UENO, Kyoto-shi (JP)

(21) Appl. No.: 19/269,428

(22) Filed: Jul. 15, 2025

(30) Foreign Application Priority Data
Jul. 26, 2024 (JP) 2024-121051

(51) Int. Cl. G01N 21/25; B41J 11/00; B41J 15/04; B41J 15/16; H04N 1/00

(52) U.S. Cl. CPC G01N 21/251; B41J 11/0095; B41J 15/04; B41J 15/16; H04N 1/00997

(57) ABSTRACT

An image inspection apparatus supports a print medium in a state that the print medium is stretched over a first roller and a second roller. The image inspection apparatus includes an imager, a color measuring part and a light-shielding member. The imager illuminates the print medium in an area wound on the first roller, receives reflected light and captures an image. The color measuring part illuminates the print medium in an area wound on the second roller, receives reflected light by a light receiver and conducts color detection on the color detection region. The light-shielding part is arranged between the imager and the light receiver on a side of a first main surface of the print medium stretched over the first roller and the second roller and configured to shield light from the imager toward the light receiver.

### CROSS REFERENCE TO RELATED APPLICATION

The disclosure of Japanese Patent Application No. 2024-121051 filed on Jul. 26, 2024 including specification, drawings and claims is incorporated herein by reference in its entirety.

### BACKGROUND OF THE INVENTION

### 1. Field of the Invention

The present invention relates to an image inspection apparatus to inspect an image recorded on a surface of a print medium and a printing apparatus including the image inspection apparatus.

### 2. Description of the Related Art

In an apparatus to form an image and record the image on a print medium using various kinds of printing techniques such as an inkjet system, for example, the recorded image is optically detected and inspected in order to retain image quality favorably. As an example, Patent Literatures 1 to 3 each disclose a technique of optically inspecting an image recorded on an elongated web-like print medium being transported while stretched over a plurality of rollers. According to these techniques, the image is inspected using two types of optical detection means.

More specifically, an image on a surface of the print medium is captured by an imager having an imaging element such as a so-called line scanner. In order to evaluate result of the imaging using more precise color criteria, color detection is conducted on the surface of the print medium by a color measuring unit (colorimeter) and result thereof is used to calibrate the imaging result.

According to the technique shown in JP2022-149111A (Patent Literature 1), for example, an imager and a colorimeter are arranged in such a manner as to face corresponding two rollers arranged adjacent to each other and wound with a print medium. According to the technique shown in JP Patent No. 3770328 (Patent Literature 2), an imager and a colorimeter are arranged in such a manner that both the imager and the colorimeter face one roller wound with a print medium. According to the technique shown in JP Patent No. 7367521 (Patent Literature 3), a colorimeter is arranged in such a manner as to face a roller wound with a print medium after being subjected to imaging by an imager.

These inspection techniques encounter the following problem not recognized by the above-descried conventional techniques. Specifically, since each of the imager and the color measuring part has a light source for emitting illumination light to the surface of the print medium, entry of stray light resulting from these rays of the illumination light into the surface of the print medium or a light-receiving element might cause measurement error. In particular, if the color measuring part is to operate on condition that a subject is illuminated with a prescribed quantity of light, stray light from the imager to emit illumination light of a comparatively large quantity might reduce measurement accuracy at the color measuring part.

Regarding this problem, the conventional techniques shown in Patent Literatures 1 and 2 give no consideration to influence caused by the stray light. In particular, according to the technique shown in Patent Literature 2, influence by the stray light is notable as imaging and color measurement are conducted on the same roller. According to the conventional technique shown in Patent Literature 3, a roller arranged between the imager and the color measuring unit can be considered to achieve at least the effect of shielding the stray light. However, as this roller comes into contact with the surface of the print medium (image recording surface), an image may be changed between a position facing the imager and a position facing the color measuring unit. This still causes reduction in measurement accuracy from the viewpoint of measurement principles of calibrating result of imaging by the imager using result of detection by the color measuring unit. In addition, Patent Literature 3 provides no mention of influence on measurement accuracy caused by the stray light.

### SUMMARY OF THE INVENTION

The present invention has been made in view of the foregoing problem, and is intended to prevent reduction in measurement accuracy due to influence by stray light in connection with a technique of inspecting an image recorded on a print medium using an imager and a color measuring part.

One aspect of the present invention is intended for an image inspection apparatus to inspect an image recorded on a first main surface of a print medium. The image inspection apparatus comprises: a support part which includes a first roller and a second roller each coming into contact with a second main surface of the print medium on an opposite side to the first main surface and supports the print medium in a state that the print medium is stretched over the first roller and the second roller without a member contacting the first main surface between the first roller and the second roller; an imager which is arranged so as to confront the first roller and configured to cause first illumination light to enter the first main surface of the print medium in an area wound on the first roller, receive reflected light from an imaging region of a region where the first illumination light enters and capture an image of the imaging region; a color measuring part which is arranged so as to confront the second roller and configured to cause second illumination light to enter the first main surface of the print medium in an area wound on the second roller, receive light reflected from a color detection region of a region where the second illumination light enters by a light receiver and conduct color detection on the color detection region; and a light-shielding part which is arranged between the imager and the light receiver on a side of the first main surface of the print medium stretched over the first roller and the second roller and configured to shield light from the imager toward the light receiver.

Another aspect of the present invention is intended for an image inspection apparatus to inspect an image recorded on a first main surface of a print medium. The image inspection apparatus comprises: an imager which is arranged so as to confront the first main surface of the print medium in an area wound on a first roller, the print medium being stretched over the first roller and a second roller each configured to come into contact with a second main surface of the print medium on an opposite side to the first main surface without a member contacting the first main surface between the first roller and the second roller, and configured to cause first illumination light to enter the first main surface, receive reflected light from an imaging region of a region where the first illumination light enters and capture an image of the imaging region; a color measuring part which is arranged so as to confront the first main surface of the print medium in an area wound on the second roller and configured to cause second illumination light to enter the first main surface, receive light reflected from a color detection region of a region where the second illumination light enters by a light receiver and conduct color detection on the color detection region; and a light-shielding part which is arranged between the imager and the light receiver on a side of the first main surface of the print medium stretched over the first roller and the second roller and configured to shield light from the imager toward the light receiver.

According to the invention having the above-described configuration, the imager and the color measuring part are arranged oppositely with the first roller and the second roller respectively. A member to contact the first main surface (a surface with a recorded image) of the print medium is absent between the first roller and the second roller. The light-shielding part for shielding stray light is arranged between the imager and the color measuring part.

More specifically, the light-shielding part is provided in such a manner as to prevent the first illumination light emitted from the imager from entering the light receiver of the color measuring part. This prevents a situation where stray light resulting from the first illumination light enters the light receiver to become a cause for reduction in measurement accuracy at the color measuring unit. Measurement accuracy at the color measuring part is thus maintained favorably, so that it is further possible to ensure excellent accuracy of result of imaging by the imager. As a member to contact the first main surface of the print medium is absent between the first roller and the second roller, it is also possible to prevent reduction in measurement accuracy due to alteration of an image resulting from such contact.

Another aspect of the present invention is intended for a printing apparatus comprising: a transport unit which transports a print medium; a printing part which records an image on a first main surface of the print medium while the print medium is transported; and an image inspection part having the same configuration as the image inspection apparatus described above and configured to inspect the image recorded on the print medium by the printing part. According to the invention with this configuration, it is possible to inspect the image recorded on the print medium with high accuracy while suppressing influence by stray light in the way described above.

As described above, according to the present invention, the light-shielding part prevents stray light resulting from the first illumination light emitted from the imager from entering the light receiver of the color measuring part. Further, alteration of an image to be caused by contact of some member with the first main surface of the print medium is also prevented. Thus, it is possible to favorably inspect an image recorded on the first main surface of the print medium while reduction in measurement accuracy due to influence by the stray light is prevented.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a schematic view showing an exemplary configuration of a printing apparatus according to the present invention.

FIG. 2 is a drawing schematically showing the internal configuration of the first printing mechanism.

FIG. 3 is a block diagram showing a hardware configuration of the print controller.

FIG. 4 is a drawing showing the configuration of the inspection unit.

FIGS. 5A to 5C are drawings illustrating the configuration and operation of the imager.

FIGS. 6A and 6B are drawings showing the configuration of the color measuring unit.

FIGS. 7A and 7B are drawings explaining an optical path of stray light and principles of shielding the stray light.

FIG. 8 is a drawing showing a modification of a configuration for shielding stray light.

FIG. 9 is a drawing showing modification of the second printing mechanism.

### DETAILED DESCRIPTION OF THE PREFERRED EMBODIMENTS

FIG. 1 is a schematic view showing an exemplary configuration of a printing apparatus according to the present invention. The printing apparatus 10 includes a printer body 200 and a print controller 100 as a controller therefor. The printer body 200 includes a sheet feeder 21, a first printing mechanism 20a, a reversing unit 27, a second printing mechanism 20b, an inspection unit 28 and a sheet winder 29. The sheet feeder 21 is configured to feed a print sheet (here, a roll of paper) P. The first printing mechanism 20a is configured to record an image by making a print on a front surface of the print sheet P. The reversing unit 27 is configured to reverse the print sheet P output from the first printing mechanism 20a between the front surface and a back surface. The second printing mechanism 20b is configured to record an image by making a print on the back surface of the print sheet P. The inspection unit 28 is configured to inspect the images printed on the print sheet P. The sheet winder 29 is configured to wind the print sheet P after the printing.

If the print sheet P is to be subjected to a subsequent step continuously after printing on both surfaces thereof is completed, the sheet winder 29 may be replaced by a processor for implementation of the subsequent step, as appropriate. In this case, the print sheet P after the printing is delivered as it is to the subsequent step without being wound.

To show a relationship between directions clearly in each of the drawings referred to below, an XYZ orthogonal coordinate system shown in FIG. 1 is introduced. Here, an XY plane indicates a horizontal plane and a Z direction indicates a vertically upward direction. As shown in FIG. 1, in the printing apparatus 10, the sheet feeder 21, the first printing mechanism 20a, the reversing unit 27, the second printing mechanism 20b, the inspection unit 28, and the sheet winder 29 are arranged in this order in the (+X) direction.

The first printing mechanism 20a prints an image on one main surface (hereafter called a “front surface Pa”) of the print sheet P. Meanwhile, the second printing mechanism 20b prints an image on the other main surface (hereafter called a “back surface Pb”) of the two main surfaces of the print sheet P on the opposite side to the front surface Pa. Note that the front surface and the back surface mentioned herein are distinguished from each other for the convenience of description. In the present embodiment, there is no substantial difference between the front surface Pa and the back surface Pb of the print sheet P. However, a print medium having a distinction between a front surface and a back surface in terms of the presence or absence of coating may be used, for example.

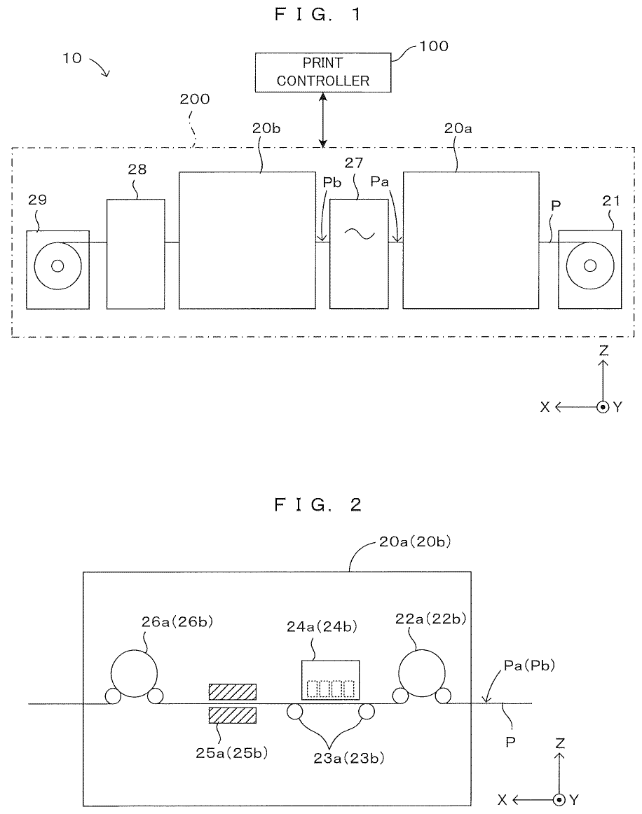

FIG. 2 is a drawing schematically showing the internal configuration of the first printing mechanism. The first printing mechanism 20a includes a first drive roller 22a, a plurality of support rollers 23a, a printing unit 24a, a drying unit 25a and a second drive roller 26a. The first drive roller 22a transports the print sheet P internally. The support rollers 23a transport the print sheet P inside the first printing mechanism 20a. The printing unit 24a makes a print on the print sheet P by ejecting ink. The drying unit 25a dries the print sheet P after the printing. The second drive roller 26a outputs the print sheet P from the inside of the first printing mechanism 20a.

In the following description, the structures provided in the first printing mechanism 20a and concerned with transport of the print sheet P, specifically, the first drive roller 22a, the second drive roller 26a, the support rollers 23a, etc. may collectively be called a “transport part.” In addition to these, the transport part may include various types of members such as an auxiliary roller for defining a transport path of the print sheet P.

The printing unit 24a is composed of inkjet head arrays of C color (cyan color), M color (magenta color), Y color (yellow color), and K color (black color) arranged in arrays in a transport direction of the print sheet P, for example. Each of the inkjet head arrays is composed of a plurality of inkjet heads (print heads) arranged in a staggered pattern. Each of the inkjet heads is provided with a large number of nozzles for ejecting ink.

The second printing mechanism 20b has the same configuration as the first printing mechanism 20a, so that description thereof is omitted. In the present specification and FIG. 2, components of the first printing mechanism 20a are denoted by signs ending with “a.” In describing components of the second printing mechanism 20b in the following, these components are denoted by signs same as those of the corresponding components of the first printing mechanism 20a and ending with “b” instead of “a.”

The print controller 100 controls the operation of the printer body 200 having the above-described configuration. When an instruction command for printout is given to the print controller 100, the print controller 100 controls the operation of the printer body 200 so as to transport the print sheet P internally from the sheet feeder 21. By doing so, the print sheet P is fed from the sheet feeder 21 with the front surface Pa pointed upward and loaded into the first printing mechanism 20a.

The first printing mechanism 20a performs a printing process in response to the instruction command from the print controller 100. Specifically, the print sheet P is transported with the front surface Pa pointed upward by the first drive roller 22a and the second drive roller 26a in a substantially horizontal direction, more specifically, in the (+X) direction. The printing unit 24a first makes a print on an upper surface (front surface Pa). Next, the drying unit 25a dries the print sheet P. In this way, an image is formed and fixed on the front surface Pa of the print sheet P.

The print sheet P ejected from the first printing mechanism 20a is reversed between the front and the back by the reversing unit 27. Specifically, the reversing unit 27 reverses the incoming print sheet P loaded with the front surface Pa pointed upward, and ejects the print sheet P with the back surface Pb pointed upward. The configuration of the reversing unit 27 may be a publicly-known configuration, so that description thereof is omitted.

The reversed print sheet P is loaded into the second printing mechanism 20b. The second printing mechanism 20b performs a printing process in response to the instruction command from the print controller 100. Specifically, the print sheet P is transported with the back surface Pb pointed upward by a first drive roller 22b and a second drive roller 26b in the (+X) direction. A printing unit 24b first makes a print on the upper surface (back surface Pb). Next, a drying unit 25b dries the print sheet P. In this way, an image is formed and fixed on the back surface Pb of the print sheet P. When the print sheet P is ejected from the second printing mechanism 20b, the print sheet P is in a state with the images formed on the both surfaces (front surface Pa and back surface Pb) thereof.

The print sheet P with the images printed on the both surfaces thereof in this way is loaded into the inspection unit 28. As will be described later in detail, the inspection unit 28 optically reads the respective images printed on the both surfaces of the print sheet P and transmits result of the reading to the print controller 100. On the basis of the information transmitted from the inspection unit 28, the print controller 100 judges whether the images have been printed with intended quality. The images are inspected in this way. The inspected print sheet P is ejected from the inspection unit 28 and wound in a roll form by the sheet winder 29.

While the exemplary configuration described herein is that of an inkjet printer to perform color printing, the present invention is further applicable to a case of employing an inkjet printer to perform single color printing. While the exemplary configuration described herein is that of an inkjet printer to use aqueous ink, the present invention is further applicable to a case of employing a printing apparatus to use UV ink (ultraviolet-curing ink) such as an inkjet printer for label printing, for example. Furthermore, the present invention may be configured to transfer a printed print sheet directly from the printing apparatus to a post processor. The present invention is further applicable to a case of using a printing apparatus (laser printer, for example) other than an inkjet printer. As described above, there is no particular limitation on the type of the printing apparatus.

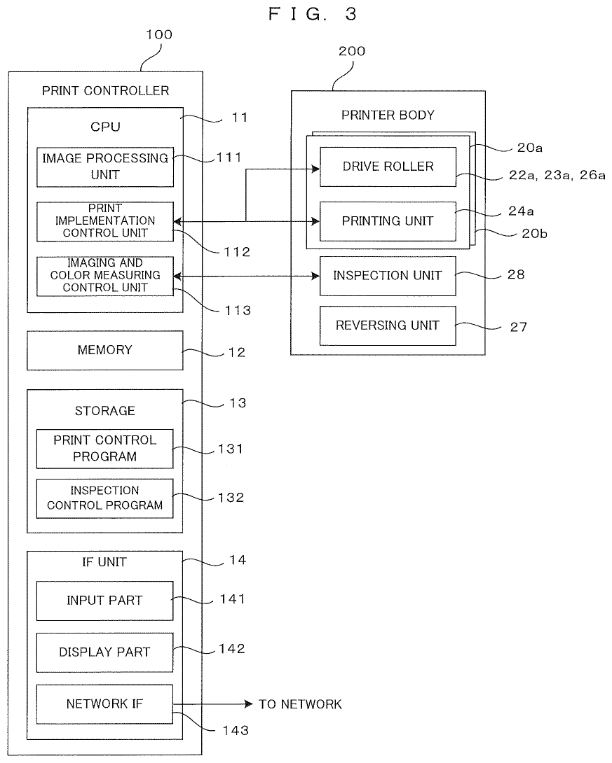

FIG. 3 is a block diagram showing a hardware configuration of the print controller. As shown in FIG. 3, the print controller 100 includes a central processing unit (CPU) 11, a memory 12, a storage (auxiliary storage device) 13, and an interface (IF) unit 14. The CPU 11 realizes various types of processes according to a control program prepared in advance. The memory 12 temporarily stores data generated during implementation of a process. The storage 13 stores result data about the process or control programs for a long term. The IF unit 14 is responsible for communication between the print controller 100 and a user or an external device. For this purpose, the IF unit 14 is equipped with an input part 141 with input devices such as a keyboard, a mouse, etc., a display part 142 composed of a display device, for example, a network IF 143 for connection to an external communication network such as a local area network (LAN) or the Internet, and others.

The storage 13 stores a print control program 131 and an inspection control program 132. The print control program 131 is a control program for controlling implementation of the printing process by the printer body 200. The inspection control program 132 is a control program for controlling implementation of image inspection processing by the inspection unit 28.

The memory 12 includes a RAM and a ROM. The memory 12 functions as a work area when the CPU 11 executes the print control program 131 and the inspection control program 132 stored in the storage 13. The print control program 131 and the inspection control program 132 are provided while being stored in a computer-readable recording medium (non-transitory recording medium) or through an external communication network.

The CPU 11 reads the print control program 131 and the inspection control program 132 from the storage 13 into the memory 12 and executes the read programs, thereby realizing various functions of the print controller 100. For example, functional blocks including an image processing unit 111, a print implementation control unit 112, and an imaging and color measuring control unit 113 are realized as software. The image processing unit 111 performs each type of processing on image data indicating details of an image to be printed on the print sheet P. The print implementation control unit 112 controls operations of the first printing mechanism 20a, the second printing mechanism 20b, the transport unit including the drive rollers 22a and 22b, and the like. The imaging and color measuring control unit 113 controls the operation of the inspection unit 28 described below in detail.

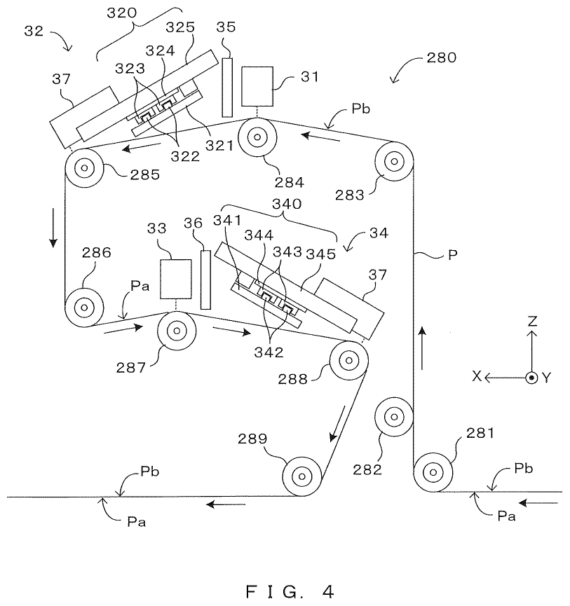

FIG. 4 is a drawing showing the configuration of the inspection unit. The inspection unit 28 has an inspection transport unit 280 including a plurality of transport rollers 281 to 289, and the print sheet P is transported while stretched over the transport rollers 281 to 289. All the transport rollers 281 to 289 are driven rollers. Specifically, the transport rollers 281 to 289 act to define a transport path in the inspection unit 28 for the print sheet P fed by the drive roller 26b of the second printing mechanism 20b and to be wound by the sheet winder 29.

Each of the transport rollers 281 to 289 has a cylindrical or columnar shape extending lengthwise in the Y direction. A center axis of each of these rollers has opposite ends in the Y direction that are rotatably supported by a pair of support frames (not shown in the drawings) arranged on the near side and the far side of the plane of paper of FIG. 4 in such a manner as to interpose each roller therebetween from the Y direction. By doing so, each of the transport rollers 281 to 289 becomes rotatable about a rotary axis extending axially in the Y direction.

The print sheet P is transported from the second printing mechanism 20b with the back surface Pb pointed upward. Thus, in the inspection transport unit 280, the transport rollers 282 to 286 come into contact with the front surface Pa of the print sheet P, and the transport rollers 281 and 287 to 289 come into contact with the back surface Pb of the print sheet P.

In FIG. 4, solid arrows drawn at corresponding positions near the print sheet P show transport directions of the print sheet P at these positions. The transport direction of the print sheet P loaded from the second printing mechanism 20b in the (+X) direction is changed to an upward direction by the transport roller 281, namely, to the (+Z) direction. Then, the transport direction of the print sheet P is changed to a direction approximate to the (+X) direction by the transport rollers 283 to 285, to a direction approximate to the (−Z) direction by the transport rollers 285 and 286, to a direction approximate to the (−X) direction by the transport rollers 286 to 288, and to a direction approximate to the (−Z) direction by the transport rollers 288 and 289 sequentially. Finally, the print sheet P is ejected in the (+X) direction by the transport roller 289.

In determining the positions of the transport rollers 281 and 289, it is preferable to set the height (position in the Z direction) of the incoming print sheet P and the position of the print sheet P in the Z direction to be ejected substantially equal to each other. By doing so, it makes possible to eliminate change in the transport path between the second printing mechanism 20b and the sheet winder 29 to be caused by insertion of the inspection unit 28 between the second printing mechanism 20b and the sheet winder 29. Specifically, the inspection unit 28 has a configuration favorable for an add-on inspection device to be mounted on an existing printing apparatus without such an inspection device.

The print sheet P is transported with the back surface Pb pointed upward along the transport path from the transport roller 283 to the transport roller 285. Meanwhile, the print sheet P is transported with the front surface Pa pointed upward along the transport path from the transport roller 286 to the transport roller 288.

An imager 31 is provided above the transport roller 284 as one of the transport rollers. The imager 31 captures an image of the back surface Pb of the print sheet P transported while wound on the transport roller 284. Another imager 33 is provided above the transport roller 287 as a different one of the transport rollers. The imager 33 captures an image of the front surface Pa of the print sheet P transported while wound on the transport roller 287. Preferably, these two imagers 31 and 33 have the same configuration.

A color measuring unit 32 is arranged above the transport roller 285. The color measuring unit 32 conducts color detection on a partial region in the back surface Pb of the print sheet P transported while wound on the transport roller 285. Another color measuring unit 34 is further provided above the transport roller 288 as a different one of the transport rollers. The color measuring unit 34 conducts color detection on a partial region in the front surface Pa of the print sheet P transported while wound on the transport roller 288. Preferably, these two color measuring units 32 and 34 have the same configuration.

A light-shielding plate 35 is arranged between the imager 31 and the color measuring unit 32. The light-shieling plate 35 shields part of illumination light emitted from the imager 31 as will be described later and going to travel toward the color measuring unit 32. More specifically, the light-shielding plate 35 prevents this illumination light from entering the color measuring unit 32 directly or entering the color measuring unit 32 after being reflected on a surrounding member. Likewise, a light-shielding plate 36 is arranged between the imager 33 and the color measuring unit 34. The light-shielding plate 36 shields light emitted from the imager 33 and going to travel toward the color measuring unit 34 directly or travel toward the color measuring unit 34 after being reflected on a surrounding member.

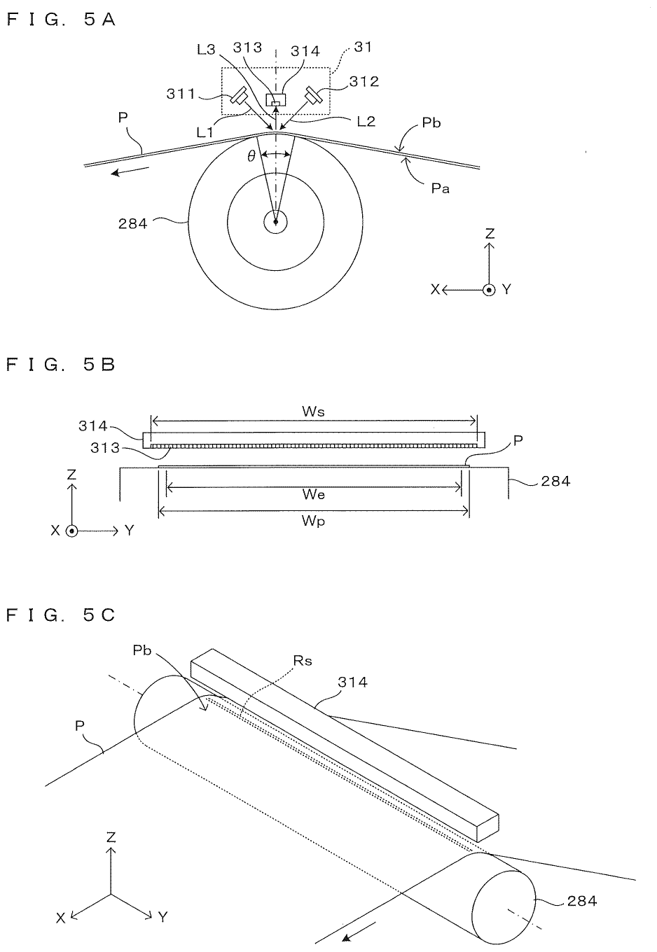

FIGS. 5A to 5C are drawings illustrating the configuration and operation of the imager. While the imager 31 is described here as one example, the other imager 33 has the same configuration in the present embodiment. As shown in FIG. 5A, the imager 31 includes illumination light sources 311 and 312 for illuminating the back surface Pb of the print sheet P wound on the transport roller 284, and a line sensor 314 with an imaging element 313 arranged close to and facing the back surface Pb. The imaging element 313 receives reflected light L3 of illumination light L1 from the illumination light source 311 and illumination light L2 from the illumination light source 312 to capture an image of the back surface Pb of the print sheet P. While the two illumination light sources 311 and 312 are provided here in order to illuminate the back surface Pb of the print sheet P from two directions, the number of illumination light sources and the arrangements thereof are not limited to these.

As shown in FIG. 5B, a large number of the imaging elements 313 are aligned in the Y direction on a lower surface of a casing of the line sensor 314 formed into a rod shape extending in the Y direction. These imaging elements 313 are pointed downward at positions differing from each other in the Y direction, namely, in a width direction of the print sheet P wound on the transport roller 284 in such a manner as to cover an entire area from one end toward the other end of the print sheet P. Specifically, the line sensor 314 is a one-dimensional image sensor extending lengthwise in the Y direction and having an imaging width Ws larger than a width Wp of the print sheet P. If ineffective regions not to be printed with images are present at the opposite ends of the print sheet P in the width direction, it is sufficient for the line sensor 314 to cover an effective region to be actually printed with an image. In this case, it is sufficient for the imaging width Ws to be larger than a width We of the effective region and the imaging width Ws is not always required to be larger than the width Wp of the print sheet P.

As shown in FIG. 5C, the line sensor 314 is arranged so as to confront (face-to-face with) the back surface Pb of the print sheet P transported while wound on the transport roller 284. The line sensor 314 receives light from a strip-shaped region (imaging region Rs) of the back surface Pb narrower in the X direction and longer in the Y direction to capture an image. In this way, it is possible to acquire an image of the imaging region Rs, namely, a one-dimensional image of the back surface Pb. Imaging is performed regularly along with movement of the transported print sheet P to receive light from a plurality of the imaging regions Rs at different positions, thereby allowing acquisition of a two-dimensional image of the back surface Pb using results of the light receptions.

Likewise, the other imager 33 has the illumination light sources 311 and 312, the line sensor 314, and the like. The imager 33 performs imaging using the imaging region Rs that is a part of a region of the front surface Pa of the print sheet P wound on the transport roller 287 and is a strip-shaped region elongated in the Y direction. Specifically, while the imaging region Rs used by the imager 31 is defined in the back surface Pb of the print sheet P, the imaging region Rs used by the imager 33 is defined in the front surface Pa of the print sheet P.

Image data acquired by the imaging is transmitted to the print controller 100, more specifically, to the imaging and color measuring control unit 113. The imaging and color measuring control unit 113 receives the image data, analyzes the image data, and judges whether an image printed on the print sheet P has intended quality. If the imaging and color measuring control unit 113 detects reduction in print quality, correction is made, as appropriate, on at least one of processing on the image data by the image processing unit 111 and an operation parameter for each unit of the printer body 200 set by the print implementation control unit 112. By doing so, retention of the print quality is encouraged. For this purpose, the imaging and color measuring control unit 113 performs the image inspection processing on the basis of result of the imaging by the imagers 31 and 33.

Imaging is performed on the back surface Pb (front surface Pa) of the print sheet P backed up by the transport roller 284 (287). The occurrence of change in a distance between the imaging region Rs on the print sheet P and the line sensor 314 (more specifically, imaging element 313) makes it impossible for the line sensor 314 to capture an image on the print sheet P correctly, resulting in reduction of the accuracy of the image inspection processing. This problem can be avoided before it happens by capturing an image of the print sheet P backed up by a member such as a roller.

If the print sheet P wound on the transport roller 284 (287) has creases, the print sheet P becomes partially floating from the transport roller 284 (287). This makes the above-described distance between the imaging region Rs and the line sensor 314 change between positions. While the print sheet P is transported by the plurality of transport rollers, the print sheet P is unavoidably caused to travel in a meandering or oblique manner and these might cause creases of the print sheet P on the transport rollers. According to the knowledge of the inventors of the present application, a likelihood of the occurrence of creases changes in response to an angle of winding the print sheet P on the transport roller (an angle denoted by a sign θ in FIG. 5A).

Specifically, as the winding angle θ becomes larger, creases are more likely to occur as a result of meandering travel, or the like. Meanwhile, if the winding angle θ is too small, the function of backing up by the transport roller 284 (287) is weakened. Experiment conducted by the inventors of the present application shows that a preferred range of the winding angle θ for preventing the occurrence of such creases on the print sheet P as will exert influence on imaging is equal to or greater than 2.5 degrees and equal to or less than 45 degrees. Note that the winding angle θ is an angle expressing a range within an entire perimeter, for example, of the transport roller 284 where the roller is in contact with the print sheet P in terms of a center angle of this roller. The concept of the “winding angle” is the same as a concept called a “contact angle” in the technical field of film transport.

Results of the imaging by the imagers 31 and 33 are subjected to influence by characteristic variations of the imagers, a drift caused by an ambient temperature, and others. To suppress reduction in inspection accuracy caused by such factors, the imaging results are compensated for using result of color detection by a colorimeter. More specifically, result of imaging of the back surface Pb by the imager 31 is compensated for using result of color detection also conducted on the back surface Pb by the color measuring unit 32. Furthermore, result of imaging of the front surface Pa by the imager 33 is compensated for using result of color detection also conducted on the front surface Pa by the color measuring unit 34. The technique of incorporating a colorimeter and a line sensor into a printing apparatus and realizing high-accuracy image inspection using detection results in combination obtained therefrom is described in detail, particularly in Patent Literature 1. The principles thereof are also applicable to the present embodiment, so that they are not described in detail here. In the present embodiment, however, principles of the inspection are not limited to these and an alternative inspection technique is also applicable.

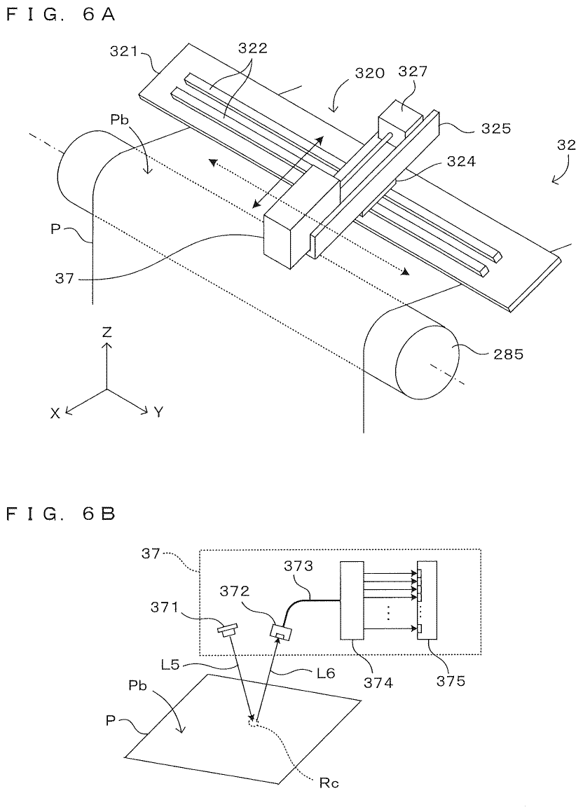

FIGS. 6A and 6B are drawings showing the configuration of the color measuring unit. While the color measuring unit 32 is described here as one example by referring to FIGS. 4, 6A and 6B, the other color measuring unit 34 has the same configuration. As shown in FIGS. 4 and 6A, the color measuring unit 32 includes a colorimeter 37 and a support mechanism 320 supporting the colorimeter 37. The support mechanism 320 has a base member 321 like a flat plate arranged diagonally above the transport roller 285. Both ends of the base member 321 in the Y direction are fixed to the support frames (not shown in the drawings) rotatably supporting the transport roller 285. The base member 321 like a flat plate has an upper surface tilted from a horizontal position toward the (+X) direction, and the upper surface is provided with a pair of guide rails 322 extended in the Y direction.

As shown in FIG. 4, sliders 323 are engaged with the respective guide rails 322 in a manner movable in the Y direction, and a plate member 324 is coupled to the sliders 323 and the guide rails 322. The plate member 324 is mounted with a support member 325 extending in a direction perpendicular to the Y direction in which the guide rails 322 extend. The support member 325 is mounted with the colorimeter 37, and an advancing and retreating mechanism 327 to move the colorimeter 37 back and forth in a lengthwise direction of the support member 325.

Thus, at the color measuring unit 32, the support member 325 is movable in the Y direction along the guide rails 322 relative to the base member 321, and the colorimeter 37 is movable back and forth relative to the support member 325 in a direction perpendicular to the Y direction. This makes the colorimeter 37 movable in the Y direction and in the direction perpendicular to the Y direction to become capable of conducting color detection at any position on the print sheet P. The support member 325 is tilted from the horizontal direction in such a manner as to become lower on the (+X) side, and a moving direction in which the colorimeter 37 moves back and forth has a component in the X direction and a component in the Z direction.

When the colorimeter 37 is located at a position projecting most in the (+X) direction, a lower surface of the colorimeter 37 comes to face the back surface Pb of the print sheet P wound on the transport roller 285. As schematically shown in FIG. 6B, an illumination light source 371 and a light receiver 372 are included in the colorimeter 37. These are provided on the lower surface of the colorimeter 37. The illumination light source 371 emits illumination light L5 toward the back surface Pb of the print sheet P at a facing position. The light receiver 372 receives reflected light L6 from a color detection region Rc as a partial region in the back surface Pb illuminated with the illumination light. For the purpose of conducting color detection with high accuracy at each point on the print sheet P, the color detection region Rc is defined as a tiny region in the print sheet P.

The reflected light L6 received by the light receiver 372 is transmitted to a spectroscope unit 374 through an optical fiber 373. The spectroscope unit 374 splits incoming light into a plurality of wavelength components and outputs the resultant components. The spectroscope unit 374 may be a unit employing a grating, may be a unit with a plurality of bandpass filters of different pass wavelengths, or the like. Each of the optical components split on the basis of each wavelength component enters a light detector 375 having a plurality of light-receiving elements. The light detector 375 outputs the quantity of received light at each wavelength as detection result. In this way, color detection is conducted in the color detection region Rc.

The detection result is transmitted to the imaging and color measuring control unit 113 of the print controller 100 and used for compensating for result of imaging by the imager 31. Specifically, the result of imaging by the imager 31 is compensated for on the basis of the result of color detection by the color measuring unit 32. Using result of the compensation, an image printed on the back surface Pb of the print sheet P is inspected.

The color measuring unit 34 has the same configuration and fulfills the same function as the color measuring unit 32. Specifically, the color measuring unit 34 includes a colorimeter 37 having the same configuration as that provided at the color measuring unit 32, and a support mechanism 340. The support mechanism 340 has a base member 341, guide rails 342, sliders 343, a plate member 344, a support member 345, and the like. Result of imaging by the imager 33 is compensated for on the basis of result of color detection by the color measuring unit 34. Using result of the compensation, an image printed on the front surface Pa of the print sheet P is inspected.

As described above, in the present embodiment, the printing apparatus 10 to print images on the both main surfaces (front surface Pa, back surface Pb) of the print sheet P includes the inspection unit 28 provided along a path of the print sheet P having been subjected to printing on both surfaces thereof. The inspection unit 28 inspects an image printed on the front surface Pa and an image printed on the back surface Pb of the print sheet P individually.

By conducting inspection on the both surfaces after completion of printing on the both surfaces instead of conducting image inspection at each completion of printing on one of the surfaces, it becomes possible to inspect images in a state near a final output item. This allows print quality of the final output item to be retained at intended quality.

Imaging by the imagers 31 and 33 and color detection by the color measuring units 32 and 34 are conducted on the print sheet P backed up by the transport roller 284 and others. This restricts change in respective distances from the imagers 31 and 33 and from the color measuring units 32 and 34 to the print sheet P, thereby allowing implementations of imaging and detection with high accuracy.

The imagers 31 and 33 and the color measuring units 32 and 34 are installed with the respective light-receiving parts pointed downward. Paper dust scatters around the transport path of the print sheet P and attachment of the paper dust to the light-receiving part increases detection error. Pointing the light-receiving part downward makes it possible to avoid such a problem before it happens.

In order to compensate for imaging result based on color detection result with high accuracy using the color detection result, it is desirable for imaging by the imager 31 and color detection by the color measuring unit 32 to be conducted on the same position on the back surface Pb of the print sheet P. This also applies to the front surface Pa. It is desirable for imaging by the imager 33 and color detection by the color measuring unit 34 to be conducted on the same position on the print sheet P.

In the present embodiment, the imager 31 and the color measuring unit 32 are provided oppositely (face-to-face) with the transport rollers 284 and 285 respectively adjacent to each other, and a member to come into contact with the print sheet P is absent between the transport rollers 284 and 285. This minimizes influence by meandering or oblique travel, deflection and others of the print sheet P to be caused unavoidably during transport, so that a positional relationship can be maintained between the imaging region Rs of imaging by the imager 31 and the color detection region Rc of color detection by the color measuring unit 32 on the back surface Pb of the print sheet P. Thus, it is possible to conduct inspection with high accuracy using results obtained at positions corresponding to each other. In particular, the absence of a member to come into contact with the print sheet P between the transport rollers 284 and 285 is advantageous in terms of preventing alteration of an image to be inspected on the print sheet P during transport.

In this sense, it is preferable to reduce a distance between the adjacent transport rollers 284 and 285. In another case, both imaging and color detection may be conducted on one transport roller. In these cases, consideration should be given to a probability that the imager 31 and the color measuring unit 32 will interfere with each other optically. Specifically, detection error might be caused if illumination light emitted from the imager 31 is received as stray light by the color measuring unit 32 or if illumination light emitted from the color measuring unit 32 is received by the imager 31. Influence by the stray light from the imager 31 toward the color measuring unit 32 is particularly notable. The first reason for this is that result of color detection by the color measuring unit 32 is required to have higher accuracy as it is used for the purpose of compensating for result of imaging by the imager 31. The second reason is that an illumination light quantity is sufficiently larger at the imager 31 than at the color measuring unit 32 as the imager 31 is to illuminate the wide imaging region Rs.

In the present embodiment, the imager 31 and the color measuring unit 32 are arranged so as to confront (face-to-face with) the transport rollers 284 and 285 respectively provided separately from each other while adjacent to each other along the transport path. Further, the light-shielding plate 35 is arranged between the imager 31 and the color measuring unit 32. Thus, efforts are being made to solve above problem. Regarding a component of the stray light, light from the imager 31 to directly enter the color measuring unit 32 has the largest quantity, but primarily reflected light reflected on the back surface Pb of the print sheet P may also have a comparatively large quantity. Desirably, the light-shielding plate 35 is provided in such a manner as to further shield an optical path of such primarily reflected light.

Furthermore, in the present embodiment, the support mechanism 320 supporting the colorimeter 37 is arranged between the transport rollers 284 and 285. A base member 321 of the support mechanism 320 is a member like a flat plate extending in the width direction of the print sheet P and further functions to shield stray light. Locating respective lower ends of the base members 321 and 341 as close as possible to the print sheet P makes it possible to enhance a light-shielding function further, particularly against reflected light on the print sheet P.

While various operations and effects described so far are fulfilled by the imager 31 and the color measuring unit 32, these operations and effects further apply to a combination of the imager 33 and the color measuring unit 34. As there is no substantial difference between the front surface Pa and the back surface Pb of the print sheet P as described above, inspection on the side of the front surface Pa and inspection on the side of the back surface Pb are desirably conducted under the same condition. This is realized by taking measures described next.

In the present embodiment, the imager 31 and the imager 33 have the same configuration, and the color measuring unit 32 and the color measuring unit 34 have the same configuration. Regarding a line sensor, for example, respective line sensors used at the imager 31 and the imager 33 have the same specification and uniform characteristics. Regarding an illumination light source, respective illumination light sources used at the imager 31 and the imager 33 cause rays of illumination light to enter the imaging region Rs in the same direction and at the same light quantity. Regarding the colorimeter 37, the respective colorimeters 37 used at the color measuring unit 32, 34 have uniform characteristics. By doing so, it becomes possible to reduce a difference between inspection conditions resulting from characteristic variations of these parts.

A positional relationship between the transport roller 284 and the imager 31 is the same as a positional relationship between the transport roller 287 and the imager 33. Specifically, while the imager 31 is arranged directly above the rotary axis of the transport roller 284 while pointed downward, the imager 33 is arranged directly above the rotary axis of the transport roller 287 while pointed downward. Furthermore, a distance between the imager 31 and the transport roller 284 is equal to a distance between the imager 33 and the transport roller 287. By setting the positional relationships uniformly in this way, it becomes possible to provide an imaging condition uniform between the imager 31 and the imager 33.

This also applies to the color measuring units 32 and 34. Specifically, the position of the color measuring unit 32 viewed from the print sheet P wound on the transport roller 285 is the same as the position of the color measuring unit 34 viewed from the print sheet P wound on the transport roller 288. A distance between the transport roller 285 and the color measuring unit 32 is equal to a distance between the transport roller 288 and the color measuring unit 34.

The color measuring units 32 and 34 are arranged symmetrical to each other with respect to a Z axis as a result of a difference in the transport direction, so that the color measuring units 32 and 34 are reversed from each other in terms of an orientation. Hence, absolute positions thereof relative to each other cannot be said to be equal in a strict sense. Meanwhile, it can be said that there is uniformity at least between a relative positional relationship between the transport roller 285 and the color measuring unit 32 and a relative positional relationship between the transport roller 288 and the color measuring unit 34. Furthermore, the respective colorimeters 37 used at the color measuring units 32 and 34 have the same specification, and degrees of tilt thereof from a horizontal plane during implementation of detection are set to the same value.

The configuration of the inspection transport unit 280 is also determined to provide a uniform inspection condition. Specifically, the transport roller 284 and the transport roller 287 have the same diameter. The winding angle θ of the print sheet P (FIG. 5A) is common between the transport rollers. This provides a uniform curvature of the wound print sheet P, so that the print sheet P can be viewed in the same state from the imagers 31 and 33.

Likewise, the transport rollers 285 and 288 have the same diameter. The angles of winding of the print sheet P on these rollers are ideally equal to each other. Meanwhile, if the print sheet P is wound deeply on the transport rollers 285 and 288 (at winding angles of equal to or greater than 45 degrees, for example) like in the present embodiment, the curvature of the print sheet P is determined substantially by the curvature of a peripheral surface of the transport roller. Thus, as long as the two transport rollers have the same diameter, setting winding angles equally between these transport rollers is not necessarily required.

A distance between the transport roller 284 and the transport roller 285 is equal to a distance between the transport roller 287 and the transport roller 288. Specifically, the length of the transport path between the transport roller 284 and the transport roller 285 is equal to the length of the transport path between the transport roller 287 and the transport roller 288. This makes a relative positional relationship between the imaging region Rs and the color detection region Rc uniform between the side of the front surface Pa and the side of the back surface Pb of the print sheet P.

To fulfill these conditions, in the inspection transport unit 280, uniformity is provided between a relative positional relationship between the transport rollers 283, 284, and 285 and a relative positional relationship between the transport rollers 286, 287, and 288. Specifically, by reversing the transport rollers 286, 287, and 288 about the Z axis and translating the transport rollers 286, 287, and 288 in the X direction while maintaining the positional relationship therebetween, the transport rollers 286, 287, and 288 become overlaid tightly on the transport rollers 283, 284, and 285 respectively. More preferably, by reversing and translating the imager 33 and the color measuring unit 34 together with the transport rollers 286, 287, and 288 while maintaining the positional relationship therebetween, the transport rollers 286, 287, and 288, the imager 33, and the color measuring unit 34 become overlaid on the transport rollers 283, 284, and 285, the imager 31, and the color measuring unit 32 respectively.

By taking the various measures descried above, it becomes possible to reduce a difference sufficiently in inspection condition between the side of the front surface Pa and the side of the back surface Pb of the print sheet P. Inspecting the both surfaces collectively after completion of printing on the both surfaces also contributes to reduction in a difference in inspection condition.

In the present embodiment, measures are also taken to suppress increase in the footprint of the printing apparatus 10 as a whole. First, image inspection on the both surfaces is conducted by the single inspection unit 28 as described above. It is possible to confine a footprint to a small area compared to provision of two inspection devices for inspecting the front surface Pa and the back surface Pb alone. Additionally, by bending the transport path of the print sheet P and defining the transport path in layers overlapping in a vertical direction as described next, it becomes possible to restrict expansion of the transport path in the horizontal direction.

Specifically, as shown in FIG. 4, in a zone belonging to the transport path of the print sheet P defined by the inspection transport unit 280 and ranging from the transport roller 283 to the transport roller 285, the transport direction of the print sheet P has a horizontal component in the (+X) direction. In this zone, the print sheet P is transported with the back surface Pb pointed upward. Meanwhile, the transport path is bent by the transport rollers 285 and 286. Therefore, the transport direction of the print sheet P has a horizontal component in the (−X) direction in a zone from the transport roller 286 to the transport roller 288. The print sheet P is transported with the front surface Pa pointed upward. With this configuration, it is possible for both respective images formed on the front surface Pa and the back surface Pb of the print sheet P to be inspected using the imagers 31, 33 and the colorimeters 37 arranged above the print sheet P and pointed downward.

A group of the transport rollers 286 to 288 is arranged below a group of the transport rollers 283 to 285. Thus, a transport path defined by the transport rollers 283 to 285 and a transport path defined by the transport rollers 286 to 288 are separated in the vertical direction while overlapping each other in a top view. For this reason, an area of the foot print occupied by the transport paths in these two zones is substantially equal to an area occupied by one zone. In this way, reduction in the footprint is encouraged.

The following describes a problem in detail relating to optical interference that might occur in the present embodiment between the imager 31 and the color measuring unit 32 and between the imager 33 and the color measuring unit 34. As described above, in the present embodiment, the light-shielding plate 35 is arranged between the imager 31 and the color measuring unit 32, and the light-shielding plate 36 is arranged between the imager 33 and the color measuring unit 34. These light-shielding plates are provided for the purpose of preventing entry of stray light resulting from illumination light emitted from each of the imagers 31 and 33 into the color measuring units 32 and 34.

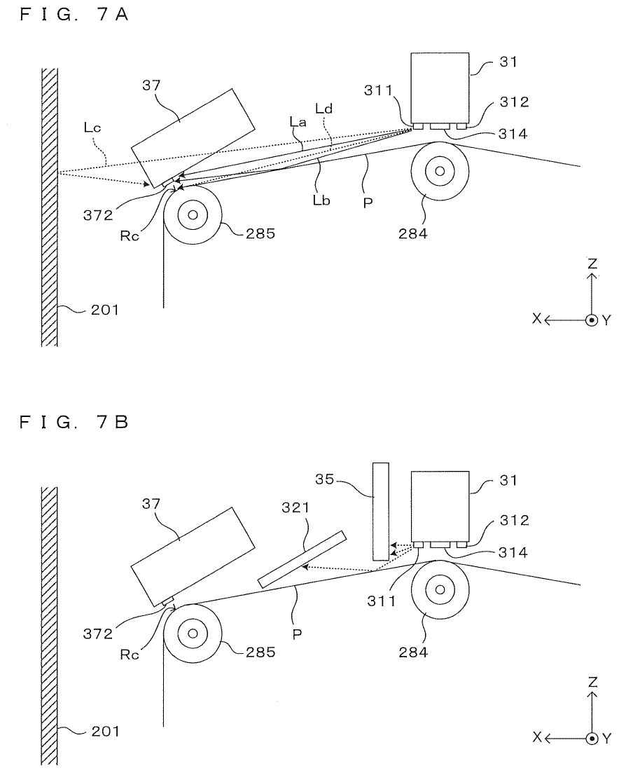

FIGS. 7A and 7B are drawings explaining an optical path of stray light and principles of shielding the stray light. In a case considered here, illumination light emitted from the imager 31 enters the color measuring unit 32 as stray light. A similar situation might also occur between the imager 33 and the color measuring unit 34. A white LED or a lamp is available as the illumination light source 311 of the imager 31, for example. While such light sources are intended simply for illumination, light therefrom has a comparatively large extension.

As shown in FIG. 7A, light emitted from the illumination light source 311 and to travel toward the light receiver 372 of the colorimeter 37 may include light as follows:
(1) Light La from the illumination light source 311 to travel directly toward the light receiver 372;
(2) Light (primarily reflected light) Lb to be regularly reflected on the upper surface (back surface Pb) of the print sheet P and then to travel toward the light receiver 372;
(3) Reflected light Lc from a reflective member 201 such as a casing of the printer body 200 or a fitting for reinforcement, for example, arranged near the transport roller 285 and the colorimeter 37; and
(4) Light Ld from the illumination light source 311 to enter the color detection region Rc on the print sheet P and then to enter the light receiver 372 as reflected light from the color detection region Rc.

According to the knowledge of the inventors of the present application, these kinds of light exert influences on result of color detection by the colorimeter 37 and their magnitudes have descending order substantially corresponding to that given above.

As shown in FIG. 7B, in the present embodiment, the light-shielding plate 35 is arranged between the imager 31 and the color measuring unit 32, more specifically, between the imager 31 and the colorimeter 37, and the light-shielding plate 35 shields light from the illumination light source 311 that might become stray light. The light-shielding plate 35 is a plate-like member extending in the Y direction like the line sensor 314, and has a light-shielding effect over the entire width direction of the print sheet P (Y direction). This prevents the stray light from the illumination light source 311 from traveling toward the light receiver 372 of the colorimeter 37.

The light-shielding plate 35 is provided at a position allowing shielding at least of the light La from the illumination light source 311 to travel directly toward the light receiver 372. More preferably, the light-shielding plate 35 is provided at a position allowing further shielding of the light Lb to be primarily reflected on the print sheet P and then to travel toward the light receiver 372. Still preferably, the light-shielding plate 35 is provided at a position further allowing shielding of the light Lc from the illumination light source 311 toward the reflective member 201. Providing the light-shielding plate 35 at a position allowing shielding of the light Lb to be primarily reflected on the print sheet P and then to travel toward the light receiver 372 is considered to voluntarily allow shielding of the light Ld from the illumination light source 311 toward the color detection region Rc.

Meanwhile, there is a certain gap between the light-shielding plate 35 and the print sheet P. This might cause the occurrence of light to pass through the gap, to be reflected on the print sheet P, and then to travel toward the colorimeter 37. In the present embodiment, the base member 321 of the support mechanism 320 (FIG. 6A) supporting the colorimeter 37 has the function of shielding such light. Specifically, the base member 321 is a member like a flat plate extending in the width direction of the print sheet P (Y direction), and the upper surface thereof is tilted from the horizontal direction toward the (+X) side. A lower end of the base member 321 is arranged in proximate to the upper surface (back surface Pb) of the print sheet P. A distance between the lower end of the base member 321 and the print sheet P can be set smaller than a distance between a lower end of the light-shielding plate 35 and the print sheet P, for example.

In this configuration, it is possible for light having entered the print sheet P from below the light-shielding plate 35 and having been reflected on the print sheet P to be shielded by the base member 321. By doing so, influence by stray light can be suppressed more effectively. In principle, the base member 321 can be responsible for the function of the light-shielding plate 35 entirely. Specifically, by determining the shape and position of the base member 321 in such a manner as to satisfy the above-described conditions for installation of the light-shielding part, the base member 321 becomes functional as an alternative light-shielding part to make the light-shielding plate 35 omissible. Meanwhile, separating the functions of these parts achieves higher degrees of freedom in the respective shapes and arrangements. By configuring a light-shielding part by using the light-shielding plate 35 and the base member 321 further functioning as a light-shielding member in combination, more excellent light-shielding effect is achieved.

Regarding reflected light from the reflective member 201, as also shown in FIG. 7A, a casing of the colorimeter 37 is tilted anticlockwise about the Y axis. This provides the casing itself with the function of shielding light traveling toward the light receiver 372 from the (+X) side with respect to the colorimeter 37. This achieves synergism effect together with the action of shielding light from the illumination light source 311 toward the reflective member 201 using the light-shielding plate 35, thereby making it possible to effectively suppress entry of stray light into the light receiver 372 via the reflective member 201.

FIG. 8 is a drawing showing a modification of a configuration for shielding stray light. In this modification, a roller member 38 to come into contact with the print sheet P from below is provided between the transport rollers 284 and 285. The roller member 38 is arranged in such a manner as to lift up the print sheet P. More specifically, the roller member 38 is arranged in such a manner that an upper end thereof projects upward further than a plane including the illumination light source 311 and the light receiver 372 indicated by a dash-dotted line in FIG. 8.

As a result, the print sheet P is supported in a state of projecting upward in a zone from the transport roller 284 to the transport roller 285. In other words, the upper surface (back surface Pb) of the print sheet P has a positive curvature in this zone. The roller member 38 and the print sheet P wound thereon have the function of shielding light from the illumination light source 311 toward the light receiver 372. Stray light having entered the print sheet P is reflected in a direction of moving further from the light receiver 372. Specifically, in this modification, the roller member 38 and the print sheet P wound thereon function as a “light-shielding part.” In this case, further providing the light-shielding plate 35 is certainly effective as well. Providing the roller member 38 along the transport path changes the winding angle of the print sheet P at each of the transport rollers 284 and 285. Therefore, the arrangement of each roller may be required to be adjusted.

For only the purpose of achieving light shielding simply, such a roller member as will come into contact with the upper surface (back surface Pb) of the print sheet P may be provided as a light-shielding part, for example. By doing so, it is possible to eliminate a gap between the roller member and the print sheet P to increase light-shielding effect. However, this brings the roller member into contact with an image between the imager 31 and the color measuring unit 32 to be inspected by the imager 31 and the color measuring unit 32. Therefore, reduction in inspection accuracy due to loss of the sameness of the image might be caused. A member to come into contact with an image is desirably absent between the imager 31 and the color measuring unit 32.

While consideration has been given here only to the influence by the illumination light source 311 at the imager 31, influence by the other illumination light source 312 can be handled in the same way. Specifically, the shape or position of a member such as the light-shielding plate 35 can be determined, as appropriate, in response to the number or arrangement of illumination light sources provided at the imager 31, intensity distribution characteristics thereof, and others, for example. Influence by stray light from the imager 33 toward the color measuring unit 34 can also be handled in the same way as that described above.

In the above-described embodiment, the independent inspection unit 28 is arranged on the (+X) side with respect to the second printing mechanism 20b, namely, downstream of the transport direction of the print sheet P from the second printing mechanism 20b to perform printing on the back surface Pb of the print sheet P. The reason for this is that this arrangement allows the first printing mechanism 20a and the second printing mechanism 20b to have the same configuration. On the other hand, from the viewpoint of reducing the footprint of the printing apparatus 10 as a whole, the inspection unit can be provided inside the second printing mechanism as described next, for example.

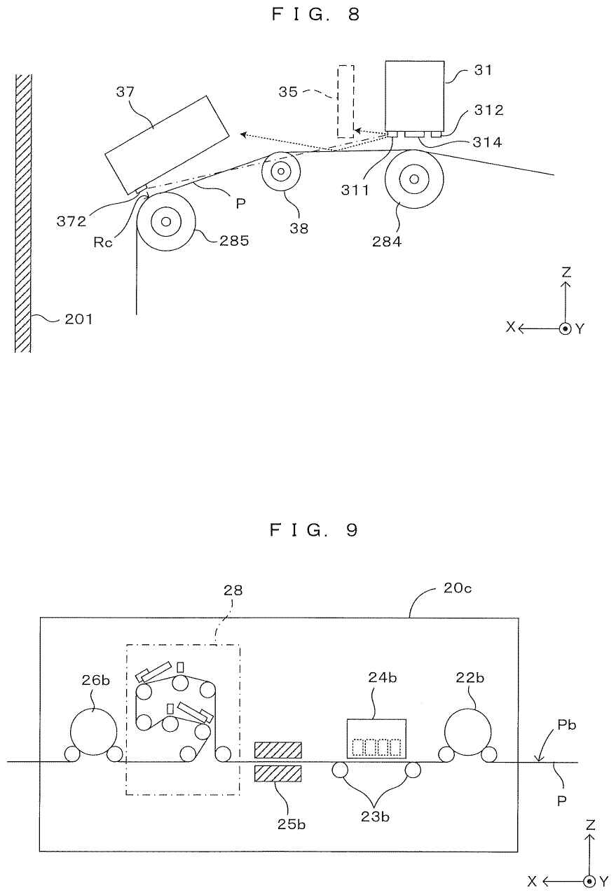

FIG. 9 is a drawing showing modification of the second printing mechanism. In this modification, structures same as those of the second printing mechanism 20b of the above-described embodiment are given the same signs and descriptions thereof are omitted. In a second printing mechanism 20c of this modification, the inspection unit 28 is interposed along a transport path between the drying unit 25b and the second drive roller 26b. The transport rollers provided in the inspection unit 28 are all driven rollers and do not have drive force for moving the print sheet P. Thus, by providing the inspection unit 28 upstream from the drive roller 26b, it becomes possible to transport the print sheet P using the drive force of the drive roller 26b. This further allows a processing unit to perform an optional subsequent step to be arranged downstream from the second printing mechanism 20c. If a mechanism to drive the print sheet P into a subsequent step is provided, the inspection unit 28 may be provided downstream from the drive roller 26b like the sheet winder 29 of the present embodiment.

As described above, by providing the inspection unit inside the printing mechanism, footprint reduction can be encouraged further than in a case where the inspection unit is configured as an independent device. Moreover, it is possible to make a transport roller required for implementation of printing further function as a transport roller in the inspection transport unit. By doing so, the number of rollers to be used is reduced to shorten a transport path, thereby allowing further reduction in the footprint.

As described above, in the present embodiment, the printing apparatus 10 and the inspection unit 28 thereof function as a “printing apparatus” and an “image inspection device” of the present invention respectively. The inspection unit 28 further functions as an “image inspection part” of the present invention. The print sheet P corresponds to a “print medium” of the present invention.

In the inspection transport unit 280, a pair of the transport rollers 284 and 285 and a pair of the transport rollers 287 and 288 each function as a “support part” of the present invention. Regarding the pair of the transport rollers 284 and 285, the transport roller 284 corresponds to a “first roller” and the transport roller 285 corresponds to a “second roller” of the present invention. In this case, the back surface Pb of the print sheet P corresponds to a “first main surface” and the front surface Pa corresponds to a “second main surface” of the present invention. On the other hand, regarding the pair of the transport rollers 287 and 288, the transport roller 287 corresponds to the “first roller” and the transport roller 288 corresponds to the “second roller” of the present invention. In this case, contrary to the above case, the front surface Pa of the print sheet P corresponds to the “first main surface” and the back surface Pb corresponds to the “second main surface” of the present invention.

The imagers 31 and 33 each function as an “imager” of the present invention, and the color measuring units 32 and 34 each function as a “color measuring part” of the present invention. The line sensor 314 corresponds to a “one-dimensional image sensor” of the present invention, and the imaging element 313 corresponds to an “imaging element” of the present invention. The light-shielding plates 35 and 36 each function as a “light-shielding part” of the present invention. The roller member 38 in the modification corresponds to a “third roller” and the “light-shielding part” of the present invention.

The colorimeter 37 corresponds to a “colorimeter” of the present invention, and the support mechanism 320 supporting the colorimeter 37 corresponds to a “colorimeter support mechanism” of the present invention. The base member 321 of the support mechanism 320 functions as a “light-shielding member” of the “light-shielding part” of the present invention. The light receiver 372 of the colorimeter 37 corresponds to a “light receiver” of the present invention. The illumination light L1 and the illumination light L2 emitted from each of the imagers 31 and 33 correspond to “first illumination light” of the present invention, and the illumination light L5 emitted from each of the color measuring units 32 and 34 corresponds to “second illumination light” of the present invention.

In the printing apparatus 10 of the present embodiment, members including the drive roller 22a and the transport roller 23a forming the transport path of the print sheet P in the first printing mechanism 20a and the second printing mechanism 20b, and the inspection transport unit 280 integrally form a “transport part” of the present invention. The printing units 24a and 24b each function as a “printing part” of the present invention.

Note that the invention is not limited to the above embodiment, and various changes other than the aforementioned ones can be made without departing from the gist of the invention. For example, in the inspection unit 28 of the above-described embodiment, the imager and the color measuring unit are arranged in this order in the transport direction of the print sheet P. However, this order is not limited this and the color measuring unit may be arranged upstream from the imager, for example.

As an example, in the present embodiment, the reversing unit 27 to reverse the print sheet P between the front and the back is arranged between the first printing mechanism 20a to print an image on the front surface Pa of the print sheet P and the second printing mechanism 20b to print an image on the back surface Pb. However, the present invention is further applicable to a printing apparatus without a mechanism for reversing a print medium such as a printing mechanism including printing units arranged in response to corresponding ones of both surfaces of the print medium, for example. The present invention is also applicable to a printing apparatus to record an image only on one surface of a print medium.

As an example, the printing apparatus 10 in the above-describe embodiment is to perform printing on the print sheet P that is elongated web-like continuous paper. Meanwhile, the present invention is further applicable to an apparatus to perform printing on cut print sheets one by one, for example.

While the inspection unit 28 of the above-describe embodiment is configured as one component of the printing apparatus 10, the inspection unit 28 may alternatively be configured as an image inspection device to conduct image inspection by being arranged alone along a transport path of an existing printing apparatus.

As has been described above by presenting the specific embodiment as an example, in the image inspection apparatus according to the present invention, the light-shielding part is preferably arranged at a position where the light-shielding part intercepts an optical path of the first illumination light from the imager to travel directly toward the light receiver, for example. More preferably, the light-shielding part is arranged at a position where the light-shielding part intercepts an optical path of primarily reflected light of the first illumination light having entered the first main surface of the print medium between the first roller and the second roller and to travel toward the color measuring unit, for example. Still more preferably, the light-shielding part is arranged at a position where the light-shielding part intercepts an optical path of reflected light of the first illumination light to travel toward the light receiver after reflected on a member provided on an opposite side to the imager with respect to the color measuring part. Further preferably, the light-shielding part is arranged at a position where the light-shielding part intercepts an optical path from the imager toward the color detection region. All of such rays of light might cause reduction in color detection accuracy by entering the light receiver. Shielding such rays of light using the light-shielding part allows reduction in detection accuracy to be prevented effectively.

As an example, the imaging region may be a strip-shaped region extending lengthwise in an axis direction of the first roller, and the imager may be a one-dimensional image sensor extended in the axis direction. In this configuration, a two-dimensional image of the print medium can be acquired by capturing images of the transported print medium periodically. Thus, it is possible to inspect an image entirely on the print medium.

In this case, it is preferable that the light-shielding part includes a plate-like member extending from one end toward the other end of the print medium in the axis direction of the second roller, for example. In this configuration, even if a region to be illuminated by the imager extends in the axis direction, it is still possible to shield this light effectively using the plate-like member.

As an example, the color measuring part may include the colorimeter provided with the light receiver and configured to conduct color detection, and the colorimeter support mechanism arranged closer to the imager than the colorimeter and configured to support the colorimeter while making the colorimeter face the print medium wound on the second roller. The light-shielding member as the light-shielding part may be provided at the colorimeter support mechanism. In this configuration, it is possible to shield stray light from the imager toward the light receiver of the colorimeter using the light-shielding member provided at the colorimeter support mechanism.

As an example, the imaging element to receive reflected light from the imaging region may be arranged above the first roller while pointed downward at the imager, and the light receiver may be arranged above the second roller while pointed downward at the color measuring part. In this configuration, each of the imager and the color measuring part is to conduct inspection downward on the print medium from above while pointed downward. A foreign matter such as paper dust occurs unavoidably along the transport path of the print medium. Attachment of such a foreign matter to the imager or to the color measuring part might hinder optical inspection. By pointing these parts downward, it becomes possible to reduce attachment of such a foreign matter.

As an example, a third roller may be provided that is configured to come into contact with the second main surface of the print medium between the first roller and the second roller to give a positive curvature to the first main surface, and at least one of the third roller and the print medium wound on the third roller may be the light-shielding part. In this configuration, by providing the third roller in such a manner as to shield an optical path of stray light from the imager toward the light receiver, it becomes possible to prevent entry of the stray light into the light receiver.

The transport part of the printing apparatus according to the present invention may be configured to transport the print medium by stretching the print medium over a plurality of transport rollers including the first roller and the second roller, for example. Specifically, the first and second rollers as components of the image inspection apparatus according to the present invention may be incorporated as parts of the transport unit configured to transport the print medium in the printing apparatus. If a transport roller provided for the purpose of performing printing is available as at least one of the first and second rollers of the present invention, for example, it is possible to encourage further reduction in the footprint of the printing apparatus as a whole.

The present invention is applicable to printing apparatuses in general to inspect an image on a surface of a print medium using an imager and a color measuring unit, and is particularly suitable for the purpose of preventing interference resulting from stray light that might occur between the imager and the color measuring unit.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image inspection apparatus for inspecting an image recorded on a first main surface of a print medium, the image inspection apparatus comprising:
a support part which includes a first roller and a second roller each coming into contact with a second main surface of the print medium on an opposite side to the first main surface and supports the print medium in a state that the print medium is stretched over the first roller and the second roller without a member contacting the first main surface between the first roller and the second roller;
an imager which is arranged so as to confront the first roller and configured to cause first illumination light to enter the first main surface of the print medium in an area wound on the first roller, receive reflected light from an imaging region of a region where the first illumination light enters and capture an image of the imaging region;
a color measuring part which is arranged so as to confront the second roller and configured to cause second illumination light to enter the first main surface of the print medium in an area wound on the second roller, receive light reflected from a color detection region of a region where the second illumination light enters by a light receiver and conduct color detection on the color detection region; and
a light-shielding part which is arranged between the imager and the light receiver on a side of the first main surface of the print medium stretched over the first roller and the second roller and configured to shield light from the imager toward the light receiver.

2. An image inspection apparatus for inspecting an image recorded on a first main surface of a print medium, the image inspection apparatus comprising:
an imager which is arranged so as to confront the first main surface of the print medium in an area wound on a first roller, the print medium being stretched over the first roller and a second roller each configured to come into contact with a second main surface of the print medium on an opposite side to the first main surface without a member contacting the first main surface between the first roller and the second roller, and configured to cause first illumination light to enter the first main surface, receive reflected light from an imaging region of a region where the first illumination light enters and capture an image of the imaging region;
a color measuring part which is arranged so as to confront the first main surface of the print medium in an area wound on the second roller and configured to cause second illumination light to enter the first main surface, receive light reflected from a color detection region of a region where the second illumination light enters by a light receiver and conduct color detection on the color detection region; and
a light-shielding part which is arranged between the imager and the light receiver on a side of the first main surface of the print medium stretched over the first roller and the second roller and configured to shield light from the imager toward the light receiver.

3. The image inspection apparatus according to claim 1, wherein
the light-shielding part is arranged at a position where the light-shielding part intercepts an optical path of the first illumination light from the imager to travel directly toward the light receiver.

4. The image inspection apparatus according to claim 2, wherein
the light-shielding part is arranged at a position where the light-shielding part intercepts an optical path of the first illumination light from the imager to travel directly toward the light receiver.

5. The image inspection apparatus according to claim 1, wherein
the light-shielding part is arranged at a position where the light-shielding part intercepts an optical path of primarily reflected light of the first illumination light having entered the first main surface of the print medium between the first roller and the second roller and to travel toward the color measuring part.

6. The image inspection apparatus according to claim 2, wherein
the light-shielding part is arranged at a position where the light-shielding part intercepts an optical path of primarily reflected light of the first illumination light having entered the first main surface of the print medium between the first roller and the second roller and to travel toward the color measuring part.

7. The image inspection apparatus according to claim 1, wherein
the light-shielding part is arranged at a position where the light-shielding part intercepts an optical path of reflected light of the first illumination light to travel toward the light receiver after reflected on a member provided on an opposite side to the imager with respect to the color measuring part.

8. The image inspection apparatus according to claim 1, wherein
the light-shielding part is arranged at a position where the light-shielding part intercepts an optical path from the imager toward the color detection region.

9. The image inspection apparatus according to claim 2, wherein
the light-shielding part is arranged at a position where the light-shielding part intercepts an optical path from the imager toward the color detection region.

10. The image inspection apparatus according to claim 1, wherein
the imaging region is a strip-shaped region extending lengthwise in an axis direction of the first roller, and the imager is a one-dimensional image sensor extended in the axis direction.

11. The image inspection apparatus according to claim 2, wherein
the imaging region is a strip-shaped region extending lengthwise in an axis direction of the first roller, and the imager is a one-dimensional image sensor extended in the axis direction.

12. The image inspection apparatus according to claim 10, wherein
the light-shielding part includes a plate-like member extending from one end toward another end of the print medium in the axis direction of the second roller.

13. The image inspection apparatus according to claim 11, wherein
the light-shielding part includes a plate-like member extending from one end toward another end of the print medium in the axis direction of the second roller.

14. The image inspection apparatus according to claim 1, wherein
the color measuring part includes:
a colorimeter provided with the light receiver and configured to conduct color detection; and
a colorimeter support mechanism arranged closer to the imager than the colorimeter and configured to support the colorimeter with making the colorimeter face the print medium wound on the second roller, wherein
a light-shielding member is provided at the colorimeter support mechanism as the light-shielding part.

15. The image inspection apparatus according to claim 2, wherein
the color measuring part includes:
a colorimeter provided with the light receiver and configured to conduct color detection; and
a colorimeter support mechanism arranged closer to the imager than the colorimeter and configured to support the colorimeter with making the colorimeter face the print medium wound on the second roller, wherein
a light-shielding member is provided at the colorimeter support mechanism as the light-shielding part.

16. The image inspection apparatus according to claim 1, wherein
an imaging element to receive reflected light from the imaging region is disposed above the first roller while pointed downward to the imager, and the light receiver is disposed above the second roller while pointed downward to the color measuring part.

17. The image inspection apparatus according to claim 1, further comprising a third roller which contacts with the second main surface of the print medium between the first roller and the second roller and is configured to give a positive curvature to the first main surface, wherein
at least one of the third roller and the print medium wound on the third roller is the light-shielding part.

18. A printing apparatus, comprising:
a transport unit which transports a print medium;
a printing part which records an image on a first main surface of the print medium while the print medium is transported; and
an image inspection part having a same configuration as the image inspection apparatus according to claim 1 and configured to inspect the image recorded on the print medium by the printing part.

19. The printing apparatus according to claim 12, wherein
the transport unit of the present invention is configured to transport the print medium by stretching the print medium over a plurality of transport rollers including the first roller and the second roller.

20. A printing apparatus, comprising:
a transport unit which transports a print medium;
a printing part which records an image on a first main surface of the print medium while the print medium is transported; and
an image inspection part having a same configuration as the image inspection apparatus according to claim 2 and configured to inspect the image recorded on the print medium by the printing part, wherein
the transport unit of the present invention is configured to transport the print medium by stretching the print medium over a plurality of transport rollers including the first roller and the second roller.
